(19) United States
(12) Patent Application Publication
(10) Pub. No.: US 2008/0272092 A1
(43) Pub. Date: Nov. 6, 2008

(54) Spot Weld Gun

(75) Inventors: Colin Luthardt, Västerås (DE); Guntram Scheible, Hirschberg (DE); Greger Fasth, Vasteras (SE); Jimmy Arantius, Vasteras (SE); Johan Moraeus, Vasteras (SE)

Correspondence Address: VENABLE LLP, P.O. BOX 34385, WASHINGTON, DC, 20043-9998, US

(73) Assignee: ABB AB, Västerås (SE)

(21) Appl. No.: 10/588,335

(22) PCT Filed: Feb. 7, 2005
(86) PCT No.: PCT/SE05/00175

§ 371 Date: Aug. 3, 2006

(30) Foreign Application Priority Data
Feb. 5, 2004 (SE) 0400258-0

(51) Int. Cl. B23K 11/10

(52) U.S. Cl. 219/91.2; 219/86.1

(57) ABSTRACT

A spot weld gun with thereto belonging power transmission being achieved by means of a rotating transformer including one primary side and one secondary side for transporting electrical power over a rotating joint. The one secondary side is adapted to provide both required power to the weld current and any required auxiliary power.

### FIELD OF INVENTION

The present invention relates to a spot weld gun with thereto belonging power transmission, where the power transmission is achieved by means of a rotary transformer with a primary side and a secondary side. The present invention also relates to a weld system and number of methods to control the weld power of a spot weld gun.

### DESCRIPTION OF THE BACKGROUND ART

During welding a spot weld gun requires a high energy current. To provide such a high current it is known to use a weld transformer. Such a weld transformer is for example shown in GB-patent no. 665 360. The spot weld gun comprises two electrodes, which are both supplied with current by a secondary winding of the weld transformer. The parts to be welded together are placed between the electrodes, and thereafter the transformer is energized and the welding is carried out. The transformer is only energized a short moment during the welding.

It is known that in applications with a spot weld gun, such as robotics used for joining processes, the head of a robot is movable within a certain space. The welding gun positioned at the head of the robot has to be fed with a welding current, some kind of means has to open and close the welding gun and these means has to be controlled according to a weld schedule.

These means are traditionally pneumatically controlled, thus requiring an air supply to the head. Recent technology has replaced the pneumatically driven spot welding guns with servo driven spot welding guns, thus replacing the air as auxiliary power with electric power.

Patent publications EP 1 221 351, EP 0 640 428, EP 0 761 367, and U.S. Pat. No. 5,928,531 describes the state of the art regarding spot welding guns with electrically controlled actuators, and U.S. Pat. No. 4,782,258 relates to a hybrid motor with an pneumatic rotor coupled to an electric rotor in a common stator housing.

Electrically controlled actuators require electrical power and transmission of control signals. Patent publications EP 0 722 811 and U.S. Pat. No. 4,507,534 relates to robots where cables for power or signal transmission are brought in various ways through rotatable joints through different tubular co portions.

Patent publications U.S. Pat. No. 4,223,313, U.S. Pat. No. 5,608,771 and U.S. Pat. No. 5,814,900 relates to contactless rotatable transformers used for power transmission in robotics, where the latter also describes the transmission of changing signals by means of aerial antennas arranged in the direct vicinity of the primary and secondary coil of the transformer.

A problem in connection with the use of a spot weld gun in a system having at least one rotatable joint is how to transport the required welding power over the rotating joint. Transporting the power via a cable has drawbacks due to mechanical wear from the rotating joint.

The trend today is to use servo driven spot weld guns, which means that the air as auxiliary power is replaced with electric power. In addition a servo loop is introduced to the tool to control force and position of the welding gun.

A problem in connection with the introduction of a servo driven weld gun in a system having rotatable joints is how to provide the spot weld gun with the required electric auxiliary power as well as the required welding power. In contrary to the welding equipment, which only requires power supply a short moment during the welding, the servo loop requires a continuous power supply. Thus, the auxiliary power should be supplied continuously and the welding current should be supplied intermittently.

When introducing wireless communication and power transmission technology, the servo loop requires additional transmission of power to run the motor which still requires auxiliary power transmission through cables and which will make the wireless power transmission more difficult to develop and more costly in the first step. A high bandwidth servo loop demands from the wireless communication though is achievable.

Using cables for power or signal transmission are also limiting the degree of movement of the spot weld gun. It is a problem to take these limitations into consideration when controlling the spot weld gun on a robots arm.

Another problem of spot weld guns according to prior art is that the transformer used to generate the weld current is heavy and gives a lever movement as the spot weld gun is to be controlled in different movements of a robot.

### SUMMARY OF THE PRESENT INVENTION

The object of the present invention is to solve one or more of the above-identified problems. According to the invention his object is achieved with a spot weld gun as specified in claim 1.

The present invention teaches that both the required power to the weld current and the required auxiliary power or any other power required on the tool is transported over the rotating joint by means of a rotating transformer. A rotating transformer comprises a primary side and a secondary side, and is arranged so that the primary and secondary side are allowed to rotate relative each other.

Preferably, the primary part of the rotating transformer is mounted on one side of the rotary joint and the secondary part of the rotating transformer is mounted on the other side of the joint. For example, if one side of the joint comprises a robot head and the other side comprises a spot welding gun, the primary side of the transformer is mounted in the robot head, and the secondary side is mounted in the spot weld gun.

This is specifically advantageous if the spot weld gun is servo driven, in which case one or several servo drives and servo motors are positioned on the secondary side of the transformer. The present invention teaches that the auxiliary power is adapted to provide the servo drives and servo motors with required power.

A servo control unit may by positioned on the secondary side of the transformer, in which case the auxiliary power is adapted to provide the servo control unit with required power.

According to an embodiment of the invention said secondary side comprises a first module adapted to transport the required power to the weld current and a second module adapted to transport the required auxiliary power. Each module comprises one or more windings, and the number of windings is adapted to transport the required power.

In a preferred embodiment, the modules are adapted to be exchangeable. Thus, it is possible to exchange a module if the requirements of the transferred power changes. For example, it is possible to change the amount of auxiliary power transferred, by exchanging the second module to a module having a different number of windings.

According to an embodiment of the invention, the primary and secondary part are detachable from each other. This embodiment makes it easy to change the spot weld gun to another tool on the robot.

According to an embodiment of the invention, said power transmission comprises a weld transformer adapted to transform the power from the rotating transformer to a current having a level suitable for spot welding. Thus, the power transmission comprises two transformers, one for transporting the power over the joint and one for transforming the transferred power to the desired level. Having different transformers for different purposes, may in some cases simplify the design of the transformers.

According to an embodiment of the invention, said rotating transformer has a resonant operation at medium frequencies, i.e. within the interval of 500 Hz to 100 kHz, preferably in the interval 800 Hz-20 kHz. Thereby, power losses in the transformer are reduced and the size of the transformer is reduced compared to having a transformer with a resonant operation at lower frequencies.

Any servo motor and thereto belonging servo drive will require auxiliary power at the same time as the spot weld gun requires its weld current. The present invention teaches that this problem may be solved in several ways.

According to an embodiment of the invention this problem may be solved by positioning a weld timer belonging to the spot weld gun at the primary side of the transformer. According to this embodiment the primary converter of the transformer is adapted to fully control the weld current.

Another problem is that the servo motor and thereto belonging servo drive will also require auxiliary power during the idle phase of the spot weld gun. Thus, the servo motor and servo drive do require continuous power supply and the spot weld gun requires intermittent power supply.

The present invention proposes two basic ways of controlling the weld current in a spot weld gun. One way is to allow the weld current to be activated through the closing of the welding electrodes belonging to the weld gun by means of the action from the servo motor, or alternatively by using a controlled weld rectifier. This allows a constant auxiliary power and a control of the weld current by closing or opening the welding electrodes, the weld current will only flow when the gun is closed.

The present invention also proposes another way of controlling the weld current in a spot weld gun, and this is by varying the transmitted power through the transformer during the welding process. This variation would also vary the auxiliary power. The present invention teaches that in order to solve this problem, the weld gun comprises an auxiliary power energy storage on the secondary side of the transformer, which auxiliary power energy storage is adapted to feed the servo drives independently of the weld current. The primary converter can fully control the weld current, while the servo drives can independently be fed by the local auxiliary power energy storage to control the weld/clamp force even during welding.

The present invention teaches that the primary side is adapted to feed said secondary side with required power to charge the auxiliary power energy storage during the idle phase of the spot weld gun.

According to another embodiment of the present invention the problem of providing both auxiliary power and weld current simultaneously may be solved by that a welding power energy storage belonging to the spot weld gun and positioned at the secondary side of the transformer is adapted to provide the weld gun with required welding voltage.

It should be understood that it is also possible to combine an auxiliary power energy storage with a welding power energy storage. The auxiliary energy storage and/or the welding power energy storage may be realised through supercapacitors.

According to another embodiment of the invention, a weld timer belonging to the spot weld gun is positioned at the secondary side of the transformer, and that it is adapted to fully control the weld current.

The present invention proposes that the used transformer may be a rotating transformer, or even a contactless rotating transformer. Such a transformer could be a modular wireless power transformer, which also may have resonant operation at medium frequencies, to have independent power available for the servo drive and the servo control. This transformer will be positioned in the joint and will thus not create a momentum with its weight as in movements created by this joint.

Regardless of embodiment, the present invention teaches that an inventive spot weld gun can be a part of, or is adapted to co act with, a weld system, and one preferred embodiment proposes that a controller belonging to the system and the weld timer are adapted to wireless communication. It should be understood that the present invention also relates to such a weld system, which system could be a robot or any fixed or movable device suitable to carry a spot weld gun.

It is also proposed that the controller and servo control unit are adapted to wireless communication.

It is specifically preferred that a standard radio communication protocol, such as bluetooth, is used for the wireless communication.

The positioning of the servo control and drive unit, and in some embodiments also the weld timer, out on the weld gun at the secondary side of the transformer allows an internal fast control loop without loading the wireless communication, which allows the use of a lower speed wireless communication. In such an embodiment the wireless link will only have to communicate updates from the robot controller at a low speed. These updates might for instance be a robots position whereby the position of the weld gun may be controlled.

It should be understood that the spot weld gun may include any other auxiliary device, such as an electric gripper, driven independently of the servo motor for the gun, and that every auxiliary device may be driven by the auxiliary power.

The present invention also relates to a number of methods to control the weld power of a spot weld gun where the secondary side of a transformer is brought to provide both the weld power and any required auxiliary power.

A first embodiment of an inventive method proposes that the weld current is brought to be activated through the closing of welding electrodes belonging to the weld gun by means of the action from a servo motor, thus providing auxiliary power both during welding and idle periods of the spot weld gun.

A second embodiment of an inventive method proposes that an auxiliary power energy storage on the secondary side may be brought to feed a servo drive independently of the weld current to control the weld or clamp force even during welding, thus providing an independently available auxiliary power source. This method teaches that the primary side of the transformer is brought to feed the secondary side with required power to charge the auxiliary power energy storage during the idle phase of the spot weld gun.

A third embodiment of an inventive method proposes that a welding power energy storage on the secondary side of the transformer is brought to provide the weld gun with required welding voltage, thus providing a constant auxiliary power even during welding.

The present invention may be applied to other joining processes than spot welding that requires two or more independent energy sources, e.g. stud welding, or clinching.

Such general use of the present invention is exemplified through various inventive methods.

A first embodiment of a general method to control the joining power of a joining process, is that the secondary side of a transformer is brought to provide both the joining power and any required auxiliary power, and that the joining power is brought to be activated through the closing of a joining tool by means of the action from one or several servo motors.

A second embodiment of a general method to control the joining power of a joining process is that the secondary side of a transformer is brought to provide both the joining power and any required auxiliary power, and that an auxiliary power energy storage on the secondary side is brought to feed any servo drives independently of said joining power to control the joining process even during joining.

According to this embodiment, the primary side of the transformer is brought to feed the secondary side with required power to charge the auxiliary power energy storage during the idle phase of the joining process.

A third embodiment of a general method to control the joining power of a joining process is that the secondary side of a transformer is brought to provide both the joining power and any required auxiliary power, and that a joining power energy storage on the secondary side is brought to provide the joining process with required joining power.

The present invention also teaches that an auxiliary power energy storage on the secondary side is brought to feed any servo drives independently of the joining process, in combination with a joining power energy storage on the secondary side that is brought to provide the joining process with required joining power.

The present invention also relates to a device for stud welding that is powered through any of the above-mentioned general methods to control the joining power of a joining process.

The present invention also relates to a device for clinching that is powered through any of the above-mentioned general methods to control the joining power of a joining process.

It will be understood that the invention is not restricted to the aforedescribed and illustrated exemplifying embodiments thereof and that modifications can be made within the scope of the inventive concept as illustrated in the accompanying Claims.

The advantages of a spot weld gun according to the present invention is that no cables will be required to transport any electrical power or signals over the joint. This will give a spot weld gun with no risk of wear and tear of cables in the joint and with a totally free movement without limitations of cables in the joint. The rotating transformer also gives the advantage of a transformer positioned in the centre of the joint, thus not creating a lever movement in movements achieved by the joint.

The fact that the same power technology is used for the welding process as well as the drive system and that this technology is concentrated out on the weld gun allows a considerable cost saving on hardware.

An embodiment where the servo motor action is used to activate the weld current makes simple use of combined magnetics for servo drive and welding. An embodiment where an auxiliary power energy storage is used on the secondary side of the transformer enables separate activation and control for the welding cycle or pattern, and reduces the average power needs over the transformer for the servo needs.

In an embodiment where a welding power energy storage is used on the secondary side of the transformer only the submission of the average welding power is needed, which is approximately 30% of the maximum welding power.

This makes the transformers magnetic devices significantly smaller and cheaper, and easier to design.

### BRIEF DESCRIPTION OF THE DRAWINGS

A spot weld gun according to the present invention will now be described in detail with reference to the accompanying drawings, in which:

FIG. 1 is a schematic and simplified illustration of a first embodiment where the weld current is controlled through the opening and closing of the welding electrodes,

FIG. 2 is a schematic and simplified illustration of a second embodiment where the weld current is controlled from the primary side of the transformer and the auxiliary poser is provided by an auxiliary power energy storage on the secondary side,

FIG. 3 is a schematic and simplified illustration of a third embodiment where a welding power energy storage is used to provide required welding voltage, and

FIG. 4 is a schematic and simplified illustration of a forth embodiment with a combination of an auxiliary power energy storage and a welding power energy storage on the secondary side.

FIG. 5 is a schematic and simplified illustration of a fifth embodiment with a modular transformer.

FIG. 6 is a schematic and simplified illustration of a sixth embodiment including a separate welding transformer.

### DESCRIPTION OF EMBODIMENTS AS PRESENTLY PREFERRED

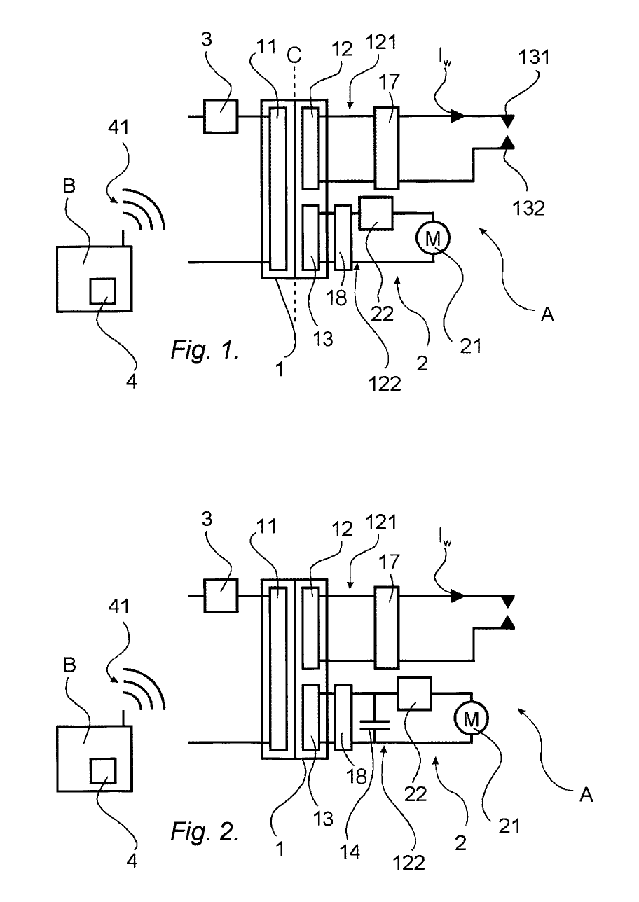

The present invention will be described with reference to FIG. 1, showing a spot weld gun A with thereto belonging power transmission. The power transmission is achieved by means of a rotating transformer 1 comprising one primary side 11 and one secondary side 12, 13 which are allowed to rotate relative each other through a joint C. The winding on the secondary side of the transformer is divided into a first part 12 adapted to transfer the weld power and a second part 13 adapted to transfer the auxiliary power.

It is specifically taught that the one secondary side 12, 13 is adapted to provide both required power 121 to the weld current I_{w} and required auxiliary power 122. The transferred power 121, 122 is an alternating power having a medium frequency. Rectifiers 17 and 18 rectify the transferred power 121 and 122.

FIG. 1 shows an embodiment with a servo driven spot weld gun A where one or several servo drives 2 and servo motors 21 are positioned on the secondary side 12. The auxiliary power 122 is adapted to provide the servo drive 2 and servo motor 21 with required power.

A servo control unit 22 is also positioned on the secondary side 12, and that the auxiliary power 122 is adapted to provide the control unit 22 with required power.

A weld timer controls the welding process of a spot weld gun. This weld timer can be positioned on either side of the transformer depending on embodiment.

According to a first embodiment illustrated in FIG. 1 the weld timer 3 is positioned at the primary side 11 of the transformer 1. In this embodiment the primary converter of the transformer 1 is adapted to fully control the weld current

The present invention proposes two basic ways of controlling the weld current in a spot weld gun according to this first embodiment.

FIG. 1 shows that the weld current I_{w} is activated through the closing of the welding electrodes 131, 132 belonging to the weld gun A by means of the action from the servo motor 21.

FIG. 2 shows an auxiliary power energy storage 14 on the secondary side 12 of the transformer 1 adapted to provide any auxiliary power 122, and thus feed any servo drive 2 independently of the weld current I_{w} to control the weld or clamp force even during welding. It is proposed that a supercapacitor on the secondary side 12 is used as an auxiliary power energy storage 14.

The primary side 11 is adapted to feed the secondary side 12 with required power to charge the auxiliary power energy storage 14 during the idle phase of the spot weld gun A.

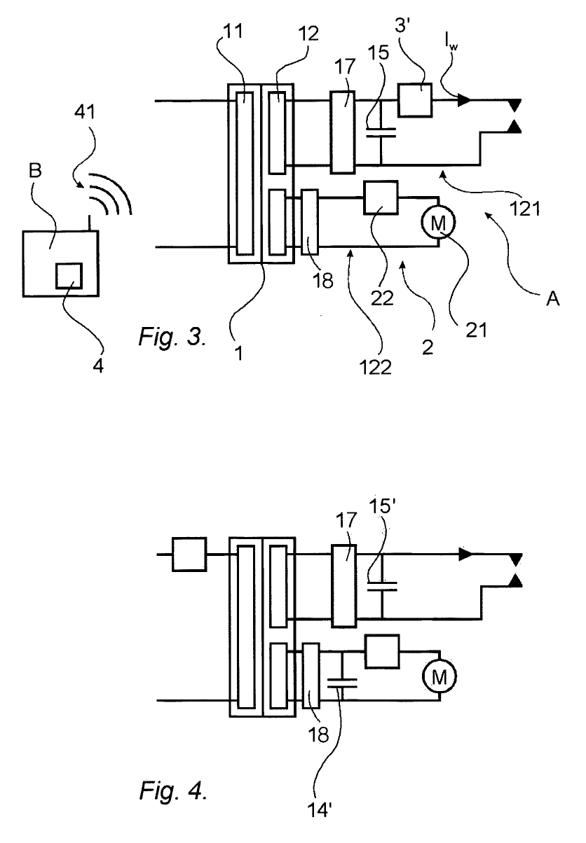

FIG. 3 illustrates a second embodiment of the present invention where a welding power energy storage 15 belonging to the spot weld gun A and positioned at the secondary side 12 of the transformer 1 is adapted to provide the weld gun with required welding voltage. It is proposed that a large supercapacitor on the secondary side 12 is used as a welding power energy storage 15.

FIG. 4 shows that it is also possible to combine an auxiliary power energy storage 14′ with a welding power energy storage 15′. The auxiliary energy storage 14′ and/or the welding power energy storage 15′ may be realised through supercapacitors.

According to the second embodiment, shown in FIG. 3, it is proposed that the weld timer 3′ is positioned at the secondary side 12 of the transformer 1. In this embodiment the weld timer 3′ is adapted to fully control the weld current I_{w}.

The present invention proposes that the used transformer 1 is a rotating transformer, or even a contactless rotating transformer. Such a transformer 1 could be a modular wireless power transformer with resonant operation at medium frequencies to have independent power available for the servo drive 2 and the servo control 22.

Regardless of embodiment, the present invention teaches that the spot weld gun A is adapted to be a part of, or to co act with, a weld system B with a controller 4 adapted to wireless communication 41 with the weld timer 3, 3′ of the spot weld gun A. The controller 4 and the servo control unit 22 are also adapted to wireless communication 41.

A standard radio communication protocol, such as bluetooth, is used for the wireless communication 41.

The positioning of the servo control 22 and drive unit 2, and in some embodiments also the weld timer 3′, at the secondary side 12 of the transformer 1 allows an internal fast control loop without loading the wireless communication 41, which allows the use of a lower speed wireless communication. In such an embodiment the wireless link will only have to communicate updates from the robot controller at a low speed, such as cycle times of ms level. These updates might for instance be a robots position whereby the position of the weld gun may be controlled.

A method to control the weld power of a spot weld gun will now be described with renewed reference to FIG. 1.

Here it is shown that the secondary side 12 of a transformer 1 is brought to provide both the weld power 121 and any required auxiliary power 122. The weld current is brought to be activated through the closing of welding electrodes 131, 132 belonging to the weld gun A by means of the action from a servo motor 21.

FIG. 2 shows another method to control the weld power of a spot weld gun, where the secondary side of a transformer is brought to provide both the weld power and any required auxiliary power.

An auxiliary power energy storage 14 on the secondary side 12 is brought to feed a servo drive 2 independently of the weld current I_{w} to control the weld or clamp force even during welding.

The primary side 11 of the transformer 1 is brought to feed the secondary side 12 with required power to charge the auxiliary power energy storage 14 during the idle phase of the spot weld gun A.

FIG. 3 shows yet another method to control the weld power of a spot weld gun, where the secondary 12 side of a transformer 1 is brought to provide both the weld power 121 and any required auxiliary power 122.

A welding power energy storage 15 on the secondary side 12 is brought to provide the weld gun with required welding voltage.

FIG. 4 shows yet another method to control the weld power of a spot weld gun, where an auxiliary power energy storage 14′ is brought to act in combination with a welding power energy storage 15′.

FIG. 5 shows an embodiment with a transformer having a modular primary and secondary side. The primary side comprises a first module 11 adapted to provide power to the weld current and to transfer the provided power to the first module 12 of the secondary side, and a second module 19 adapted to provide power to the auxiliary power and to transfer the provided power to the second module 13 of the secondary side. This embodiment can be combined with the other solutions for providing auxiliary power and welding power at the same time, described in connection with FIGS. 2-4.

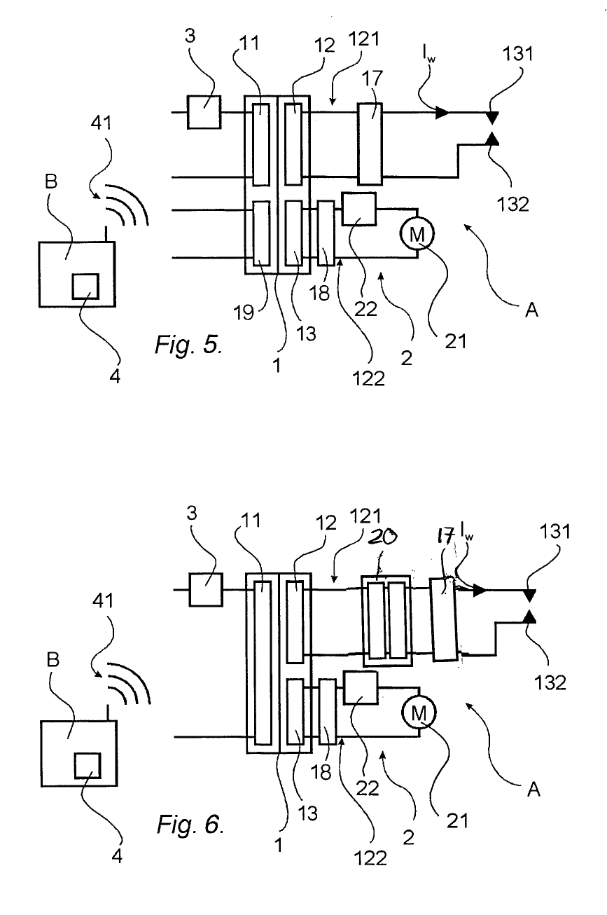

FIG. 6 shows an embodiment with a separate welding transformer 20 adapted to transform the welding power from the rotating transformer to a suitable welding current. This embodiment can be combined with the other solutions for providing auxiliary power and welding power at the same time, described in connection with FIGS. 2-4.

1. A spot weld gun, comprising:
power transmission comprising a rotating transformer comprising one primary side and one secondary side for transporting electrical power over a rotating joint, wherein said one secondary side is adapted to transport both required power to the weld current and required auxiliary power.

2. The spot weld gun according to claim 1, wherein said secondary side comprises a first module adapted to transport the required power to the weld current and a second module adapted to transport the required auxiliary power.

3. The spot weld gun according to claim 2, wherein said first and second module are adapted to be exchangeable.

4. The spot weld gun according to claim 1, wherein said primary and secondary part are detachable from each other.

5. The spot weld gun according to claim 1, wherein said power transmission comprises a weld transformer adapted to transform the power from the rotating transformer to a current having a level suitable for spot welding.

6. The spot weld gun according to claim 1, wherein said rotating transformer has a resonant operation at frequencies within the interval of 500 Hz to 100 kHz.

7. The spot weld gun according to claim 1, wherein said spot weld gun is servo driven, that one or several servo drives and servo motors are positioned on said secondary side, and wherein said auxiliary power is adapted to provide said servo drives and servo motors with required power.

8. The spot weld gun according to claim 7, wherein a servo control unit is positioned on said secondary side, and wherein said auxiliary power is adapted to provide said control unit with required power.

9. The spot weld gun according to claim 8, wherein a weld timer belonging to said spot weld gun is positioned at the primary side of said transformer, and wherein a primary converter of said transformer is adapted to fully control said weld current.

10. The spot weld gun according to claim 9, wherein said weld current is activated through the closing of the welding electrodes belonging to said weld gun by means of the action from said servo motor.

11. The spot weld gun according to claim 1, wherein said weld gun comprises an auxiliary power energy storage, and wherein said auxiliary power energy storage is adapted to feed said servo drives independently of said weld current to control the weld or clamp force even during welding.

12. The spot weld gun according to claim 11, wherein said primary side is adapted to feed said secondary side with required power to charge said auxiliary power energy storage during the idle phase of said spot weld gun.

13. The spot weld gun according to claim 1, wherein said spot weld gun comprises a welding power energy storage, and wherein said welding power energy storage is adapted to provide said weld gun with required welding voltage.

14. The spot weld gun according to claim 11, wherein said spot weld gun comprises a combination of said auxiliary power energy storage and said welding power energy storage.

15. The spot weld gun according to claim 1, wherein a weld timer belonging to said spot weld gun is positioned at the secondary side of said transformer, and wherein said weld timer is adapted to fully control said weld current.

16. The spot weld gun according to claim 1, wherein said rotating transformer is a contactless rotating transformer.

17. The spot weld gun according to claim 1, wherein the spot weld gun is adapted to be mounted on a robot or any other fixed or movable device suitable to carry said spot weld gun.

18. A weld system, comprising:
a spot weld gun comprising power transmission comprising a rotating transformer comprising one primary side and one secondary side for transporting electrical power over a rotating joint, wherein said one secondary side is adapted to transport both required power to the weld current and required auxiliary power.

19. The weld system according to claim 18, further comprising a controller and a weld timer adapted for wireless communication.

20. The weld system according to claim 19, further comprising a servo control, wherein said controller and said servo control unit are adapted for wireless communication.

21. The weld system according to claim 18, wherein said system is a robot.

22. The weld system according to claim 18, wherein said system is any fixed or movable device suitable to carry a spot weld gun.

23. A method to control a weld power of a spot weld gun, the method comprising:
transporting both required power to a weld current and required auxiliary power for controlling the spot weld gun over a rotating joint by means of a rotary transformer.

24. A method to control a weld power of a spot weld gun, the method comprising:
bring a secondary side of a rotary transformer to provide both said weld power and any required auxiliary power, and
bringing said weld power to be activated through closing of welding electrodes belonging to said weld gun by means of an action from one or several servo motors.

25. A method to control a weld power of a spot weld gun, the method comprising:
bringing a secondary side of a rotary transformer to provide both said weld power and any required auxiliary power, and
bringing an auxiliary power energy storage on said secondary side to feed any servo drives independently of said weld power to control the weld or clamp force even during welding.

26. The method according to claim 24, wherein a primary side of said transformer is brought to feed said secondary side with a required power to charge an auxiliary power energy storage during an idle phase of said spot weld gun.

27. A method to control a weld power of a spot weld gun, the method comprising:
bringing a secondary side of a transformer to provide both said weld power and any required auxiliary power, and
bringing a welding power energy storage on said secondary side to provide said weld gun with required welding voltage.

28. A method to control the weld power of a spot weld gun, the method comprising:
bringing a secondary side of a transformer to provide both said weld power and any required auxiliary power,
bringing an auxiliary power energy storage on said secondary side to feed any servo drives independently of said weld power, and
bringing a welding power energy storage on said secondary side to provide said weld gun with required welding voltage.

29. A method to control a joining power of a joining process, the method comprising:
bringing a secondary side of a transformer to provide both said joining power and any required auxiliary power, and
bringing said joining power to be activated through closing of a joining tool by means of action from one or several servo motors.

30. A method to control the joining power of a joining process, the method comprising:
bringing a secondary side of a transformer to provide both said joining power and any required auxiliary power, and
bringing an auxiliary power energy storage on said secondary side to feed any servo drives independently of said joining power to control the joining process even during joining.

31. The method according to claim 30, wherein a primary side of said transformer is brought to feed said secondary side with required power to charge said auxiliary power energy storage during an idle phase of said joining process.

32. A method to control the joining power of a joining process, the method comprising:
bringing a secondary side of a transformer to provide both said joining power and any required auxiliary power, and
bringing a joining power energy storage on said secondary side to provide said joining process with required joining power.

33. A method to control the joining power of a joining process, that the method comprising:
bringing a secondary side of a transformer to provide both said joining power and any required auxiliary power,
bringing an auxiliary power energy storage on said secondary side to feed any servo drives independently of said joining process, and
bringing joining power energy storage on said secondary side to provide said joining process with required joining power.

34. A device for stud welding, wherein said device is powered through a method according to claim 29.

35. A device for clinching, wherein said device is powered through a method according to claim 29.
